(19) United States
(12) Patent Application Publication
(10) Pub. No.: US 2017/0141665 A1
(43) Pub. Date: May 18, 2017

(54) Linear Actuator, Hydraulic Bearing, and Motor Vehicle with such a Hydraulic Bearing or Linear Actuator

(71) Applicant: ContiTech Vibration Control GmbH, Hannover (DE)

(72) Inventors: Robert Genderjahn, Hannover (DE); Max Werhahn, Hannover (DE); Peter Marienfeld, Marklohe (DE)

(73) Assignee: ContiTech Vibration Control GmbH, Hannover (DE)

(21) Appl. No.: 15/319,833

(22) PCT Filed: Jun. 15, 2015
(86) PCT No.: PCT/EP2015/063261

§ 371 Date: Dec. 19, 2016

(30) Foreign Application Priority Data
Jun. 23, 2014 (DE) 10 2014 211 949.9

(51) Int. Cl. H02K 33/16; F16M 11/04; F16M 11/18; H02K 1/17; H02K 1/34

(52) U.S. Cl. CPC H02K 33/16; H02K 1/17; H02K 1/34; F16M 11/18; F16M 11/043

(57) ABSTRACT

The invention relates to an electromagnetic linear actuator (16) with a stator (18) and an armature (20) which can be moved relative to the stator (18). The stator (18) has at least one permanent magnet (22) and at least one coil (24), the stator (18) has a conductive element (26) made of a ferromagnetic material, the conductive element (26) extends over the at least one permanent magnet (22) and/or the at least one coil (26), and the armature (18) forms a yoke (34) made of a ferromagnetic material in the longitudinal direction L for the conductive element (26). The invention further relates to a hydraulic bearing (2) with a support spring (36), a working chamber (4), which is filled with a hydraulic fluid, a compensating chamber (6), a partition (8) which is arranged between the working chamber (4) and the compensating chamber (6), a throttle channel (10) which is formed between the working chamber (4) and the compensating chamber (6) for exchanging hydraulic fluid, and a control membrane (12) which is paired with the partition (8) and which is designed to change a working chamber volume (14) of the working chamber (4). The hydraulic bearing (2) has an electromagnetic linear actuator (16) according to the invention, and the armature (20) is mechanically connected to the control membrane (12). The invention additionally relates to a motor vehicle with such a hydraulic bearing (2).

The invention relates to a linear actuator having a stator and having an armature which is movable relative to the stator.

The invention also relates to a hydraulic mount, having a load-bearing spring, a working chamber which is filled with a hydraulic fluid, an equalization chamber, a partition which is arranged between the working chamber and the equalization chamber, a throttle duct which is formed between the working chamber and the equalization chamber and which serves for the exchange of hydraulic fluid, a control diaphragm which is assigned to the partition and which is designed for the variation of a working chamber volume of the working chamber, and having the electromagnetic linear actuator, wherein the armature of the linear actuator is mechanically connected to the control diaphragm.

The invention also relates to a motor vehicle which comprises a vehicle frame, an engine and an engine mount in the form of a hydraulic mount, which engine mount produces a connection, with mounting action, between the engine and the vehicle frame.

Linear actuators having a stator and having an armature mounted movably relative to said stator are known from the prior art. In this context, the focus is on the relative movement between the stator and the armature. Where an armature movable relative to the stator is referred to, this is preferably also intended to mean a stator movable relative to the armature. Hydraulic mounts, also referred to as hydraulic bearings, are likewise known from the prior art. They serve for the elastic support of assemblies, in particular of motor vehicle engines. By way of such hydraulic mounts situated for example between an engine and a chassis of a motor vehicle, it is firstly sought to prevent engine vibrations from being transmitted to the chassis, and secondly, it is sought to achieve that the vibrations of the chassis that arise during driving operation cannot pass, or can pass only having been damped, from the chassis to the engine. Here, consideration must be given to the known conflict in the field of vibration isolation which consists in the fact that the mount should firstly be as rigid as possible in order to be able to accommodate high loads or mount forces, and secondly must have a soft characteristic in order to isolate to the greatest possible extent vibrations that arise over as broad as possible a frequency range.

In their basic version, such hydraulic bearings normally have a rubber element as a load-bearing spring in conjunction with a hydraulic damper. The rubber element is often in the form of a hollow cone. The load-bearing spring can thus form a casing wall of the working chamber. The load-bearing spring is thus also to be understood as a load-bearing body. On the upper, pointed end side of the hollow cone, there is provided an upper cover to which there is attached a connection element for the fastening of the engine. The connection element is normally a threaded bolt which can be screwed to the engine.

Here, the hydraulic damper normally comprises at least two chambers, specifically the stated working chamber and an equalization chamber. In the longitudinal direction of the hydraulic mount, the equalization chamber is normally arranged below the working chamber. To separate the working chamber and the equalization chamber from one another, a partition is arranged between the equalization chamber and the working chamber. Furthermore, a throttle duct which is formed between the working chamber and the equalization chamber is provided for the exchange of hydraulic fluid. The throttle duct is preferably formed at least in sections by the partition. Alternatively, the throttle duct may also be formed separately from the partition. The hydraulic fluid in the working chamber, the equalization chamber and the throttle duct preferably forms the entire hydraulic volume of the hydraulic mount, unless further additional volumes are provided in special embodiments. As hydraulic fluid, use is preferably made of a mixture of oil and water or a fluid with glycol.

When the hydraulic mount is subjected to load, a force acts on the load-bearing spring in a longitudinal direction of the hydraulic mount, such that said load-bearing spring elastically deforms. Said deformation is also referred to as compression of the load-bearing spring. If the working chamber is reduced in size as a result of the compression of the load-bearing spring, the pressure in the working chamber increases, such that a part of the hydraulic fluid of the working chamber flows through the throttle duct into the equalization chamber. The throttle duct is preferably designed so as to constitute a flow resistance for the flowing hydraulic fluid. The flow through the correspondingly formed throttle duct thus generates dissipation and therefore damping work.

The equalization chamber is preferably equipped with at least one wall part which is deformable in the manner of a diaphragm, such that the part of the hydraulic fluid which flows into the equalization chamber can be accommodated.

A hydraulic mount of said type is known for example from the document DE 10 2010 060 886 A1 or from the document DE 10 2012 008 497 A1.

The damping characteristics of such hydraulic mounts are frequency-dependent owing to their type of construction. Static or quasi-static loads below a frequency of 5 Hz are in this case normally accommodated by the load-bearing spring, which exhibits relatively high stiffness.

Low-frequency vibrations, that is to say vibrations with frequencies of approximately 5 to 20 Hz, which generally occur with large amplitudes, are intensely damped by way of the interaction of the two hydraulic chambers via the throttle duct. Here, the damping arises with the flow of at least a part of the hydraulic fluid of the working chamber through the throttle duct into the equalization chamber and vice versa, with corresponding damping work being performed.

High-frequency vibrations, that is to say vibrations in the frequency range above that from 20 Hz to for example 50 Hz, 100 Hz or 200 Hz, are transmitted with only very little damping, or virtually without damping, owing to the inertia, viscosity and incompressibility of the hydraulic fluid and/or the high stiffness and inertia of the load-bearing spring. Although said vibrations generally only occur with small amplitudes, they are of relatively high importance owing to their acoustic action.

For better isolation of such vibrations, the partition between working chamber and equalization chamber may be formed so as to be at least partially flexible or with a free travel. Such a solution is however considered to no longer be sufficient with regard to many damping requirements, in particular with regard to the ever-increasing demands for comfort in motor vehicles.

With regard to the improved isolation of such vibrations, use is nowadays made of so-called actively controlled hydraulic mounts which have in each case a linear actuator, also referred to as linear actuating means. Electromagnetic linear actuators which have in each case one stator and one armature have proven to be particularly expedient. Here, the armature is formed so as to be mounted movably with respect to the stator, such that the armature can be deflected relative to the stator in a longitudinal direction of the linear actuator. For the hydraulic mount, the armature is mechanically connected to a control diaphragm which is assigned to the partition. The control diaphragm may in this case be formed by a flexible part of the partition. It is however also possible for the control diaphragm to be enclosed by the partition and to thus be regarded as a constituent part of the partition. The control diaphragm can be elastically deformed in its normal direction. By virtue of the armature being mechanically coupled to the control diaphragm, it is possible by way of the electromagnetic linear actuator for the control diaphragm to be deformed in controlled fashion in its normal direction. Here, it may be provided that the armature is not connected directly to the controlled diaphragm, with a joint mechanism and/or a plunger, for example, rather being provided which are arranged between the armature and the control diaphragm in order to transmit movements and/or forces from the armature to the control diaphragm. With the deformation of the control diaphragm in its normal direction, the hydraulic volume of the working chamber changes, because the control diaphragm forms a part of the partition with respect to the working chamber. The electromagnetic linear actuator of the hydraulic mount thus also serves for controlling the hydraulic volume of the working chamber.

If the hydraulic mount is used for the mounting of an engine of a motor vehicle, sensors of the motor vehicle may be used in order to transmit the vibrations emitted by the engine to an as far as possible only highly damped extent to an interior compartment, or to even completely decouple the vibrations of the engine. For this purpose, it is for example possible for a sensor to be provided which can measure vibrations of the engine or of the chassis. Alternatively, it is also possible for multiple sensors to be provided at various locations of the engine and/or of the chassis.

If high-frequency vibrations are detected by the sensor for measuring the vibrations of the chassis, the control diaphragm of the partition can be deflected synchronously by the linear actuator. Here, the direction of the deflection may be defined by the type of construction of the partition or of the control diaphragm. The vibrations of the engine give rise to correspondingly high-frequency pressure fluctuations in the hydraulic fluid of the working chamber. With the synchronous deflection of the control diaphragm, said high-frequency pressure fluctuations are as far as possible completely balanced. In the best case, compensation is thus realized, such that said high-frequency vibrations are not transmitted by the hydraulic mount. Correspondingly high-frequency vibrations thus do not give rise to noise emissions, or give rise to only very low noise emissions, in the interior compartment of the motor vehicle.

By way of the discussed actuation of the electromagnetic linear actuator and of the corresponding action on the control diaphragm, it is thus sought to realize a lowering of the dynamic spring rate in the range of the high-frequency vibrations. In other words, it is sought to switch the hydraulic mount into a “soft” state for high-frequency vibrations.

For the compensation of inertia forces, structures are also known in which the control diaphragm is formed by a piston in a cylinder, and the piston is acted on at a rear side by the hydraulic fluid and at a front side by a compressed air volume. A hydraulic bearing of said type is disclosed for example in EP 0 561 703 A1, wherein the solution proposed here is characterized by a cumbersome and complex construction.

In the case of known hydraulic mounts, it is a disadvantage that, depending on a mass of the linear actuator, an undesired resonance arises in the event of vibrations in a particular frequency range. Similar effects may also arise in other usage situations of the linear actuator. These include for example the linear actuator being used for an active chassis mount of a motor vehicle or for the active adjustment of a mount in general. Furthermore, the linear actuator can be used as a vibration absorber. Other fields of use of the linear actuator are conceivable.

In the case of an armature of the linear actuator of “high” mass being used, said resonance may lie in the working range of the hydraulic mount, of the chassis mount or of some other device having a linear actuator of said type. The resonance peak that then arises during operation leads to an undesired increase of the dynamic spring rate of the hydraulic mount, of the chassis mount or of the device. It is often the case that, above this frequency, it is scarcely possible to realize a compensation action or controllability. The dynamic stiffness thus increases considerably in the corresponding frequency range about the abovementioned resonance. As a result, in the case of the hydraulic mount, it is for example possible for the vibrations emitted by the engine to be transmitted at least substantially undamped to the chassis of the motor vehicle, with the result, for example, that a corresponding noise is clearly perceptible in the vehicle interior.

The invention is therefore based on the object of providing a linear actuator and/or a hydraulic mount which exhibits a higher resonance frequency under dynamic load. In particular, the resonance frequency should be higher than 50 Hz, 100 Hz, 150 Hz or 200 Hz.

According to a first aspect, the object is achieved by way of the electromagnetic linear actuator according to the invention, comprising a stator and an armature which is movable relative to the stator, wherein the stator has at least one permanent magnet and at least one coil, the stator has a conductive element composed of ferromagnetic material, the conductive element engages over the at least one permanent magnet and/or the at least one coil, and the armature forms, in a longitudinal direction, a yoke composed of ferromagnetic material for the conductive element. The longitudinal direction is to be understood to mean the longitudinal direction of the linear actuator, which is thus also the longitudinal direction of the stator and of the armature.

According to a further aspect, the object is achieved by way of the hydraulic mount according to the invention, comprising a load-bearing spring, a working chamber which is filled with a hydraulic fluid, an equalization chamber, a partition which is arranged between the working chamber and the equalization chamber, a throttle duct which is formed between the working chamber and the equalization chamber and which serves for the exchange of hydraulic fluid, and a control diaphragm which is assigned to the partition and which is designed for the variation of a working chamber volume of the working chamber, and having the electromagnetic linear actuator according to the invention, wherein the armature is mechanically connected to the control diaphragm.

Where features, details and advantages of the electromagnetic linear actuator are described below in conjunction with the hydraulic mount according to the invention, these are self- evidently also intended to apply independently of the hydraulic mount and vice versa in each case, such that reference is always or can always be made reciprocally with respect to the disclosure of the individual aspects of the invention.

With regard to a basic mode of operation of an electromagnetic linear actuator, reference is made to the document DE 198 39 464 C2. The electromagnetic linear actuator is therefore a reluctance linear actuator.

According to the invention, the stator has a conductive element composed of ferromagnetic material. Said conductive element therefore serves for concentrating, conducting and/or diverting a magnetic field. The coil is to be understood to mean an electromagnetic coil having at least one, preferably multiple windings. To close the respective ends of the conductive element for a magnetic field, the armature is composed of ferromagnetic material and is formed, in a longitudinal direction, as a yoke for the conductive element. In this case, the longitudinal direction is likewise to be understood to mean the longitudinal direction of the linear actuator. To ensure the mobility of the armature relative to the stator, it is preferable for an air gap to be provided between the stator and the armature. If the stator is of ring-shaped form the armature is inserted into the cylindrical cavity of the ring-shaped stator, the air gap may likewise be of ring-shaped form. By virtue of the fact that the armature is in the form of a yoke in the longitudinal direction, the air gap remains constant even in the event of a movement of the armature in the longitudinal direction. The armature can thus maintain an at least substantially constant spacing with respect to the stator. The linear actuator thus exhibits particularly linear transmission characteristics, which ensures simple controllability.

To maintain a spacing between the armature and the stator, it is preferable for a bearing arrangement to be provided between the armature and the stator, which bearing arrangement permits a movement of the armature in the longitudinal direction. Further degrees of freedom may be provided for the bearing arrangement. However, the bearing arrangement prevents a movement in a transverse direction extending transversely with respect to the longitudinal direction. For this purpose, springs extending in a transverse direction between the stator and the armature are known from the prior art.

Without energization of the at least one coil, only the at least one permanent magnet generates a permanent magnetic field, which acts on the conductive element and on the yoke formed by the armature. Correspondingly static magnetic field lines form. The permanent magnetic field of the at least one permanent magnet is preferably oriented in a transverse direction, that is to say in a direction transverse with respect to the longitudinal direction. If the coils are not energized, it is also the case that a static magnetic state of the linear actuator is realized, wherein the armature assumes a particular rest position.

In the event of an energization of the at least one coil of the stator, the armature is pulled in the longitudinal direction into the cavity of the stator. The pulling movement of the armature can be attributed to a constructive superposition of the coil magnetic field generated by the at least one coil and of the permanent magnetic field in an upper section of the conductive element, and a destructive superposition of the coil magnetic field and of the permanent magnetic field in a lower section of the conductive element. The constructive and destructive superposition may also be realized in a reversed configuration if the current flows for example in the opposite direction. In this case, not a pulling movement but rather an oppositely directed movement of the armature would occur.

The action of force can thus be attributed to the fact that the armature forms, in the longitudinal direction, a yoke composed of ferromagnetic material for the conductive element, and the coil magnetic field is attenuated by the permanent magnetic field at the upper section of the conductive element and is amplified at the lower section of the conductive element or vice versa. A corresponding effect may also be realized with multiple permanent magnets. For example, if a first and a second permanent magnet are provided, wherein the two permanent magnets are spaced apart from one another in the longitudinal direction and the at least one coil is arranged between the two permanent magnets in the longitudinal direction, in particular with a superposition in the longitudinal direction, the two permanent magnets may each substantially be responsible for the constructive and destructive superposition, respectively, of the magnetic fields.

A major advantage of the electromagnetic linear actuator according to the invention, whose stator has both the at least one permanent magnet and the at least one coil, consists in the reduction of the armature mass or of the weight of the armature. In relation to known embodiments of a linear actuator based on the reluctance principle, the armature of which bears either the at least one permanent magnet or the at least one coil, the armature according to the invention is relieved of this load. This is because the armature according to the invention is, in the longitudinal direction, formed as a yoke composed of ferromagnetic material for the conductive element. Whereas the fraction of the armature mass in relation to the total mass of the linear actuator often amounted to approximately 50% in the case of known embodiments, it is possible for the armature mass of the linear actuator according to the invention to be reduced to approximately 15% of the total mass of the linear actuator. The force of the linear actuator is maintained despite a reduction of the armature mass. As a result of the relocation of the at least one permanent magnet or of the coil from the armature to the stator, the mass of the linear actuator, which serves for example for the control of the control diaphragm, is also reduced. As a result of the relocation, it is also the case that the static magnetic field in the armature is lessened, and the superposition of the magnetic fields takes place for the most part in the lower and upper sections of the conductive element. It is thus possible for a wall thickness of the armature, that is to say the extent of said armature in a transverse direction, to be kept particularly small, without the risk of magnetic saturation. It is thus possible for the wall thickness or the diameter of the armature to be produced to such an extent that, in the event of full energization of the at least one coil, the ferromagnetic material of the armature is again close to saturation.

The reduction of the armature mass also results in a reduction of the oscillating mass of the hydraulic mount, of the chassis mount or of the device, which may each have a corresponding linear actuator, which leads to an increase of the first system eigenfrequency of the hydraulic mount, of the chassis mount or of the device. Correspondingly, the lowermost frequency at which resonance occurs in the hydraulic mount, in the chassis mount or in the device is increased.

With the reduction of the armature mass, it is thus possible for the control diaphragm of the hydraulic mount to be controlled in the range of high-frequency vibrations, in particular in a frequency range from 20 Hz to 300 Hz, preferably in the frequency range from 20 Hz to 200 Hz. The hydraulic mount according to the invention is thus designed for isolating vibrations even in the high-frequency range. Corresponding effects may arise in a usage situation for a chassis mount or for other devices. In the case of the hydraulic mount being used as an engine mount for the mounting of an engine on a chassis of a motor vehicle, the hydraulic mount according to the invention makes a major contribution to a reduction of noise emissions, originating from the engine, in the vehicle interior compartment. Here, both body-borne noise and airborne noise occur.

A preferred embodiment of the linear actuator is characterized in that the armature is free from permanent magnets and coils. The armature can thus be of particularly lightweight and/or small form. The magnetic field of the linear actuator is furthermore generated exclusively by the stator. If, in this embodiment of the linear actuator, the hydraulic mount is acted on with high-frequency vibrations, these act by the control diaphragm on the armature, which owing to its reduced mass can follow such a high-frequency vibration. The hydraulic mount in such an embodiment is thus particularly well-suited to the isolation of high-frequency vibrations.

A further preferred embodiment of the linear actuator is characterized in that the conductive element has a longitudinal section extending in the longitudinal direction of the linear actuator, a lower collar extending in a transverse direction of the linear actuator, and an upper collar extending in the transverse direction of the linear actuator, wherein the upper collar is spaced apart from the lower collar in the longitudinal direction. The conductive element thus preferably has an upper collar and a lower collar and a longitudinal section extending between the collars. It is basically possible for the longitudinal section to extend in the longitudinal direction beyond the collars. It is however preferable for the longitudinal section to end in the longitudinal direction at the respective collar. The conductive element is thus preferably of C-shaped or comb-shaped form in cross section. Said conductive element is thus suitable for engaging over the at least one permanent magnet and/or the at least one coil. To close the respective ends, formed by the upper collar and lower collar, of the conductive element for a magnetic field, the armature is composed of ferromagnetic material and is formed, in a longitudinal direction, as a yoke for the conductive element. As stated above, when the at least one coil of the stator is energized, the armature is pulled in the longitudinal direction into the cavity of the stator. For the embodiment of the conductive element with collars, the pulling movement of the armature can be attributed to a constructive superposition of the coil magnetic field generated by the at least one coil and of the permanent magnetic field at the upper collar, and a destructive superposition of the coil magnetic field and of the permanent magnetic field at the lower collar, or vice versa. The action of force is thus based on the fact that the armature forms, in the longitudinal direction, a yoke composed of ferromagnetic material for the conductive element, and the coil magnetic field is attenuated by the permanent magnetic field at one of the collars and is amplified at the other collar. It is thus essential that the armature is composed of a ferromagnetic material in order to form a yoke between the upper collar of the conductive element and the lower collar of the conductive element.

A further preferred embodiment of the linear actuator is characterized in that the at least one permanent magnet is arranged adjacent to one of the collars. The proximity, thus defined, between the at least one permanent magnet and said one of the collars ensures that the permanent magnetic field influences a coil magnetic field. The at least one permanent magnet is particularly preferably arranged directly adjacent to said one of the collars. The desired constructive or destructive superposition of the magnetic fields is thus realized, such that the armature can, by energization of the at least one coil, be moved in controlled fashion in the longitudinal direction. It is particular preferable for two permanent magnets, specifically an upper permanent magnet and a lower permanent magnet, to be provided, wherein the upper permanent magnet is arranged adjacent to the upper collar and the lower permanent magnet is arranged adjacent to the lower collar.

A further preferred embodiment of the linear actuator is characterized in that each of the collars projects beyond the longitudinal section in the same transverse direction, wherein the at least one permanent magnet and/or the at least one coil are/is arranged between the collars. The transverse direction is formed transversely with respect to the longitudinal direction. The two collars and the longitudinal section may thus be arranged in C-shaped or comb-shaped fashion with respect to one another in cross section. Here, the opening of said C shape or comb shape preferably points toward the armature. A receiving region into which the at least one permanent magnet and/or the at least one coil are/is inserted is preferably formed between the upper collar and the lower collar in the longitudinal direction. It is thus possible for the collar, the at least one permanent magnet and/or the at least one coil to be arranged one behind the other in the longitudinal direction. By virtue of the fact that the armature is in the form of a yoke for the conductive element, a coil magnetic field generated by the coil is concentrated in ring-shaped fashion by the conductive element and the armature. By way of this embodiment of the hydraulic mount, it is possible for particularly high forces of the associated linear actuator to be ensured.

A further preferred embodiment of the linear actuator is characterized in that the at least one permanent magnet and the at least one coil are arranged one behind the other in the longitudinal direction. In this embodiment, the at least one permanent magnet and the at least one coil extend in the longitudinal direction. The linear actuator thus has a particularly small width or a particularly small diameter—that is to say the respective extent of the linear actuator in a direction transverse with respect to the longitudinal direction. A linear actuator of said type is advantageously expedient for use in particularly constrictive structural spaces, for example in the front-end structure of a motor vehicle.

A further preferred embodiment of the linear actuator is characterized in that each coil is arranged between two of the permanent magnets in the longitudinal direction. The permanent magnetic field of each of the two permanent magnets is preferably oriented in the transverse direction. Said permanent magnetic fields are thus preferably oriented in the same direction. Through the selection of two mutually separate permanent magnets, it is particularly easily possible for the coil magnetic field to be constructively superposed at one of the two collars of the conductive element and for the coil magnetic field to be destructively superposed at the other collar. This embodiment of the linear actuator is thus characterized by its simple and effective construction. It may alternatively be provided that multiple coils are arranged between the two permanent magnets. Said multiple coils are however superposed, in terms of their action, to form a common coil with a common coil magnetic field, such that the abovementioned effects in the interaction with the permanent magnets apply analogously.

A further preferred embodiment of the linear actuator is characterized in that each permanent magnet is arranged between two of the coils in the longitudinal direction. Here, it is likewise possible to realize an asymmetrical configuration of the superposed magnetic fields, such that the armature can be moved in controlled fashion in the longitudinal direction by energization of the coils.

A further preferred embodiment of the linear actuator is characterized in that the permanent magnet or at least one of the permanent magnets is arranged behind or in front of the at least one coil in the transverse direction. The at least one permanent magnet and the at least one coil can thus be arranged one behind the other in the transverse direction of the stator. The stator and/or the armature can thus be of particularly short form in their respective longitudinal direction. Furthermore, it has been found in practice that this embodiment offers particularly high forces of the linear actuator. For this purpose, an arrangement of the permanent magnets or of the multiple permanent magnets between the at least one coil and the armature in the transverse direction is advantageous. If the stator is of ring-shaped form, it is, in a preferred embodiment, provided that the at least one permanent magnet is arranged radially inside the at least one coil.

A further preferred embodiment of the linear actuator is characterized in that each coil directly adjoins at least one of the permanent magnets. This embodiment ensures that each coil magnetic field generated by a coil has at least one permanent magnetic field superposed thereon. This ensures the desired constructive and/or destructive superposition of the magnetic fields even during a movement of the armature.

A further preferred embodiment of the linear actuator is characterized in that the yoke extends in the longitudinal direction L from a lower web via a middle section to an upper web, wherein each of the webs projects beyond the middle section in the transverse direction. With this embodiment of the armature, the magnetic fields induced in the yoke are likewise concentrated in C-shaped fashion. In practice, it has been found that, with such concentration, particularly high forces in the longitudinal direction of the armature can be realized. Correspondingly, the armature can be made more compact in order to be be able to impart a force of equal magnitude, for example to the control diaphragm of the hydraulic mount. With a more compact embodiment of the armature, it is furthermore the case that the first system eigenfrequency is increased, such that a linear actuator of said type has a yet further increased resonance frequency. The hydraulic mount having a linear actuator of said type is thus suitable for the effective isolation of even relatively high-frequency vibrations.

A further preferred embodiment of the linear actuator is characterized in that each upper web and each upper collar are arranged in a common upper plane, and/or each lower web and each lower collar are arranged in a common lower plane. This applies in particular in the static situation. Thus, a spacing between the upper collar and the upper web and/or a spacing between the lower collar and the lower web define(s) the width of the air gap between the stator and the armature. To make the air gap as small as possible and thus reduce magnetic losses, only the webs and/or the collars have to be produced with particularly high precision. This can be ensured with relatively little production outlay.

A further preferred embodiment of the linear actuator is characterized in that the conductive element has at least one finger which engages into a space between coil and adjacent permanent magnet. This embodiment may be used in particular if a multiplicity of permanent magnets and a multiplicity of coils are arranged in each case alternately one behind the other in the longitudinal direction of the stator. In this case, the fingers of the conductive element can contribute to the concentration of the respective magnetic fields. This reduces the magnetic losses.

A further preferred embodiment of the linear actuator is characterized in that a magnetic field direction of the permanent magnets is oriented in the transverse direction. In practice, it has been found that the orientation of the magnetic field directions of the permanent magnets in the same direction serves for a uniform superposition of the coil magnetic field. A linear actuator with permanent magnets formed in this way thus has a preferred linear transmission function. In the case of a hydraulic mount having a linear actuator of said type, the control diaphragm can thus be controlled particularly precisely, such that measured vibrations can be isolated particularly effectively.

A further preferred embodiment of the linear actuator is characterized in that a magnetic field direction of the at least one coil is oriented in the longitudinal direction. This refers to the coil magnetic field which emerges directly from the respective coil. Said coil magnetic field is thereupon concentrated in ring-shaped fashion by the conductive element and the armature, such that said coil magnetic field can have the at least one permanent magnetic field destructively and/or constructively superposed thereon.

A further preferred embodiment of the linear actuator is characterized in that the armature is mounted by way of a slide bearing arrangement. The slide bearing arrangement makes it possible for the armature to slide in the longitudinal direction of the stator. The slide bearing arrangement can thus also be understood to be a slide bearing. By contrast to the diaphragm springs known from the prior art for the mounting of the armature, a slide bearing arrangement requires no arms which project radially outward from the armature and which are fastened to the stator. The armature can thus have a particularly small cross section, without elements projecting beyond its radially outer wall, which elements have a tendency to collide with other components of the linear actuator or, if the linear actuator is used for a hydraulic mount, to collide with components of the hydraulic mount. In other words, no arm-like elements which brake a stroke movement of the armature in undesired fashion are attached to the armature.

With regard to the slide bearing arrangement, it can furthermore be stated that a sliding resistance is independent of the deflection of the armature in the longitudinal direction relative to the stator. This means that the armature can perform even a large stroke without a resulting occurrence of proportionally increased reaction forces generated exclusively by the armature. Here, the reaction forces which, for example in the usage situation for a hydraulic mount, may originate from an associated control diaphragm are initially disregarded. The linear actuator with the slide bearing arrangement of the armature thus does not have a deflection-dependent stiffness. Thus, for the actuator, no force reserves have to be structurally provided in order to perform a relatively large deflection of the armature. It is thus possible for an actuator of said type to have a particularly small structural form. In practice, it has also been found that a slide bearing has a longer service life than a diaphragm spring for the mounting of the armature.

A further preferred embodiment of the linear actuator is characterized in that the slide bearing arrangement is at least substantially free from ferromagnetic material. This applies in particular to those parts of the slide bearing arrangement which are not formed by the armature and/or by the stator. By virtue of at least the remaining parts of the slide bearing arrangement being free from ferromagnetic material, said parts can also have no adverse effect during a deflection of the armature relative to the stator. In particular, non-ferromagnetic materials do not generate any restoring forces based on a magnetic interaction. An actuator of said type is thus particularly precisely controllable.

A further preferred embodiment of the linear actuator is characterized in that the armature forms, on an associated side facing toward the stator, a bearing surface of the slide bearing arrangement, and a slide element of the slide bearing arrangement is fastened to a stator side facing toward the armature, which slide element, by way of an associated side facing toward the armature, forms a counterpart bearing surface of the slide bearing arrangement. The side of the armature and the side of the stator refer to respectively associated outer sides. For the bearing action of the armature, the armature lies by way of the bearing surface against the counterpart bearing surface so as to be movable in sliding fashion in the longitudinal direction. The counterpart bearing surface is formed by the slide element, such that the slide element is designed for transmitting forces in the transverse direction of the actuator. To ensure a good bearing action even in the event of a deflection of the armature in the longitudinal direction, the slide element is fastened to the stator. This yields a positionally static arrangement of the slide element on the stator, which makes the structural design simpler and lengthens the service life of the actuator. This is because an inadvertent slippage of the slide element can be reliably prevented as a result of the fastening of the slide element to the stator.

A further preferred embodiment of the linear actuator is characterized in that the slide element is arranged between the upper collar and the lower collar in the longitudinal direction L of the linear actuator. The slide element serves for the transmission of forces in the transverse direction that can act between the stator and the armature. By virtue of the slide element being arranged between the upper collar and the lower collar, the slide element in any case adjoins the upper collar and the lower collar in the longitudinal direction. The slide element however does not extend beyond these in the longitudinal direction. In other words, the stator pole surfaces formed by the two collars are not covered by the slide element. To be able to transmit the forces acting in the transverse direction between the armature and the stator, it has been found in practice that the slide element should have a certain slide element width or slide element thickness extending in the transverse direction in order to realize adequate structural stability. By virtue of the fact that the slide element does not extend beyond the collars in the longitudinal direction, a spacing between the armature and the stator pole surfaces formed by the collars is not defined by the slide element width. This is because, in the case of a C-shaped embodiment, the slide element can be at least partially engaged over. This embodiment of the actuator thus makes it possible for a spacing in the transverse direction between the stator pole surfaces and the armature or the associated armature pole surfaces to be designed at least substantially freely from the slide element width, and thus so as to be particularly small. A particularly small spacing between the stator pole surfaces and the armature or the associated armature pole surfaces reduces an associated magnetic resistance between the stator pole surfaces and the armature or the armature pole surfaces, which increases the power of the actuator or the compactness of the actuator.

A further preferred embodiment of the linear actuator is characterized in that the slide element is enclosed in the stator between the lower collar and the upper collar. The stator may thus have, between the lower collar and the upper collar, a depression into which the slide element is inserted and then fastened to the stator. This makes it possible to realize a positively locking and non-positively locking connection between the slide element and the stator. Such an embodiment is particularly robust and durable. Furthermore, the slide element can have an adequate slide element width or slide element thickness, which is advantageous for the mechanical stability of the slide element, without the need for this to result in the slide element projecting out of the stator to a great extent. Furthermore, said embodiment makes it possible for the spacing between the stator pole surfaces and the armature or the associated armature pole surfaces to be structurally designed as far as possible independently of the slide element width.

A further preferred embodiment of the linear actuator is characterized in that the slide element projects in the transverse direction beyond the stator pole surfaces formed by the collars. It would basically be possible for the abovementioned depression to be designed so as to fully receive the slide element. In this case, however, there is the risk of the armature coming into mechanical contact with the collar or with the stator pole surfaces, which can lead to intense mechanical friction. Said mechanical friction must however be avoided in order to realize uniform operating characteristics of the actuator even over a relatively long service life. The slide element is therefore preferably fastened to the stator, and/or inserted into a depression between the collars, such that the slide element projects in the transverse direction beyond the stator pole surfaces formed by the collars. The armature preferably forms, by way of a side facing toward the slide element, a bearing surface, and the slide element preferably forms, by way of a side facing toward the armature, a counterpart bearing surface, wherein the bearing surface lies against the counterpart bearing surface so as to be movable in sliding fashion in the longitudinal direction. As a result of the slide element projecting beyond the collars of the stator, it is possible for the armature to slide in contactless fashion over the collars or stator pole surfaces. This ensures a particularly long service life of the actuator. Furthermore, the spacing between the stator pole surfaces and the armature, or the associated armature pole surfaces, can be defined by a height by which the slide element projects beyond the collars in the transverse direction. In other words, the abovementioned spacing between the armature or the armature pole surfaces and the stator pole surfaces can be structurally defined by way of the structural design of the slide element. Since the slide element does not extend over the stator pole surfaces in overlapping fashion, a gap forms between the stator pole surfaces and the armature or the armature pole surfaces. This is preferably an air gap.

A further preferred embodiment of the linear actuator is characterized in that the bearing surface of the slide bearing arrangement and the armature pole surfaces provided for the yoke are formed on a common, uninterrupted armature side. A transition from the bearing surface to one of the armature pole surfaces is thus continuous. The bearing surface and the armature pole surfaces are particularly preferably arranged in alignment with one another.

They may thus be arranged in a common plane or form a common cylindrical surface. The advantage of this embodiment is evident in particular when the armature is deflected in the longitudinal direction. Here, it should, by way of example, be taken into consideration that the slide element extends from the upper collar to the lower collar of the stator and projects in the transverse direction beyond the collars in the direction of the armature. In the rest state of the actuator, the armature lies by way of the bearing surface against the counterpart bearing surface formed by the slide element. It is preferable for in each case one armature pole surface to be situated adjacently above the counterpart bearing surface in the longitudinal direction and below the counterpart bearing surface in the longitudinal direction. By virtue of the fact that the counterpart bearing surface and the armature pole surfaces transition into one another in uninterrupted fashion, a deflection of the armature in the longitudinal direction is not prevented by the armature pole surfaces. Rather, a repartitioning of the side of the armature on which the counterpart bearing surface and the armature pole surfaces are formed by the armature is possible. If the armature is for example deflected upward in the longitudinal direction, a relative displacement of the counterpart bearing surface downward in the longitudinal direction occurs at the abovementioned side of the armature. Where a surface formed exclusively as an armature pole surface was previously still formed in a lower section of the armature on said side of the armature, the slide element now also bears against the armature. Here, too, it is then possible for forces to be transmitted in the transverse direction, which ensures the continued alignment of the armature relative to the stator. It is thus possible for the counterpart bearing surface and the armature pole surfaces to each have a dual function, at least in sections, when the armature is deflected in the longitudinal direction. A particularly simple embodiment of the armature which has both a bearing surface and armature pole surfaces on one side in a common alignment may for example be in the form of a unipartite armature composed of or comprising a ferromagnetic material. It is furthermore preferably possible for this to apply in particular to that section of the armature which is situated opposite the stator at least in the rest position. It is thus possible for the armature or the associated section to be, for example, in the form of a hollow cylindrical component composed of or comprising a ferromagnetic material, with a cylindrical, radially outside shell surface. Said shell surface then forms both the counterpart bearing surface and the armature pole surfaces. A cylindrical shell surface of said type has no undercuts or other discontinuous transitions. The armature particularly preferably has an at least substantially identical surface roughness on the counterpart bearing surfaces and on the armature pole surfaces. Said surface roughness is preferably very low. It is thus possible for said surfaces to be of polished form. It is thus possible for the armature to be deflected in the longitudinal direction with particularly low friction, wherein the cylindrical shell surface of the armature can slide on the slide element in the longitudinal direction.

A further preferred embodiment of the linear actuator is characterized in that a stator pole surface of the stator and an armature pole surface, arranged opposite the stator pole surface, of the armature are spaced apart from one another in the transverse direction of the linear actuator by a gap, wherein a gap width of the gap is smaller than a slide element width of the slide element. This preferably applies to each stator pole surface of the stator which is arranged so as to be spaced apart by a gap from a respectively oppositely arranged armature pole surface. The gap width is the spacing in the transverse direction of the actuator between a stator pole surface and an armature pole surface arranged opposite in the transverse direction of the actuator. The slide element width is the extent of the slide element in the transverse direction of the actuator. The slide element is preferably inserted into a depression or a receiving space between the collars of the stator. Here, it is furthermore preferably provided that the slide element projects beyond the collars in the transverse direction toward the armature. The height by which the slide element projects beyond the collars is thus dependent on the depth to which the slide element is inserted into the depression. It is thus possible for the depth of the depression to structurally also define the height by which the slide element projects beyond the collars. The armature lies by way of the bearing surface against the counterpart bearing surface of the slide element. The abovementioned height thus also defines the gap width. Said height and consequently also the gap width are in each case smaller than the slide element width. The slide element width can thus be designed such that the slide element has advantageous structural stability. The gap width resulting from this however does not increase the preferably small gap width, because the slide element can be inserted into said depression of the stator. In other words, a particularly small gap width can be selected in terms of construction for the actuator, and at the same time, a mechanically stable slide element can be used for the slide bearing arrangement of the armature.

A preferred embodiment of the hydraulic mount with the linear actuator according to the invention is characterized in that the armature is composed of the yoke or of the yoke and a holder for the connection of the yoke to the control diaphragm. In this embodiment, the armature performs substantially two tasks. On the one hand, said armature is composed of a ferromagnetic material in order to form a yoke between the upper section of the conductive element and the lower section of the conductive element. On the other hand, the armature is mechanically connected to the control diaphragm in order to deflect the latter such that a variation of the associated volume in the working chamber occurs. For this purpose, the armature may be mechanically connected directly to the control diaphragm. Alternatively, a holder and/or a mechanism may be provided which are/is designed for connecting the armature to the control diaphragm. The armature is thus of particularly simple and/or compact form. This promotes a low weight of the armature, such that said armature ensures a particularly high first system eigenfrequency of the hydraulic mount.

According to a further aspect, the object mentioned in the introduction is also achieved by way of a motor vehicle which comprises a vehicle frame, an engine and an engine mount which produces a connection, with mounting action, between the engine and the vehicle frame, wherein the engine mount is formed by the hydraulic mount according to the invention, in particular according to one of the embodiments above. Here, features, details and advantages that have been described in conjunction with the hydraulic mount according to the invention and/or the linear actuator self-evidently also apply in conjunction with the motor vehicle according to the invention and vice versa in each case, such that reference is always or can always be made reciprocally with respect to the disclosure of the individual aspects of the invention.

The invention will be described below, without restriction of the general concept of the invention, on the basis of exemplary embodiments and with reference to the drawings. In the drawings:

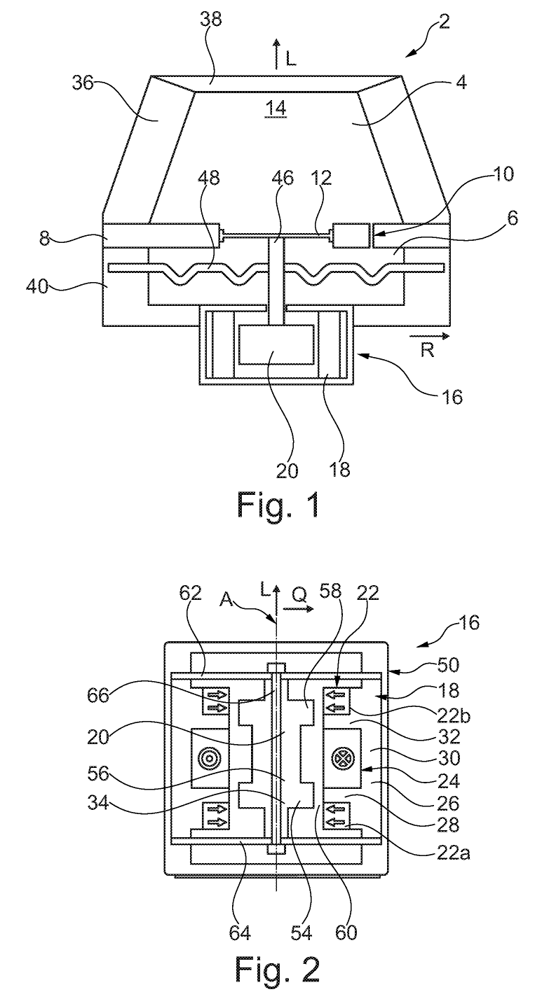

FIG. 1 shows a schematic cross-sectional view of a hydraulic mount,

FIG. 2 shows a schematic cross-sectional view of a first embodiment of a linear actuator,

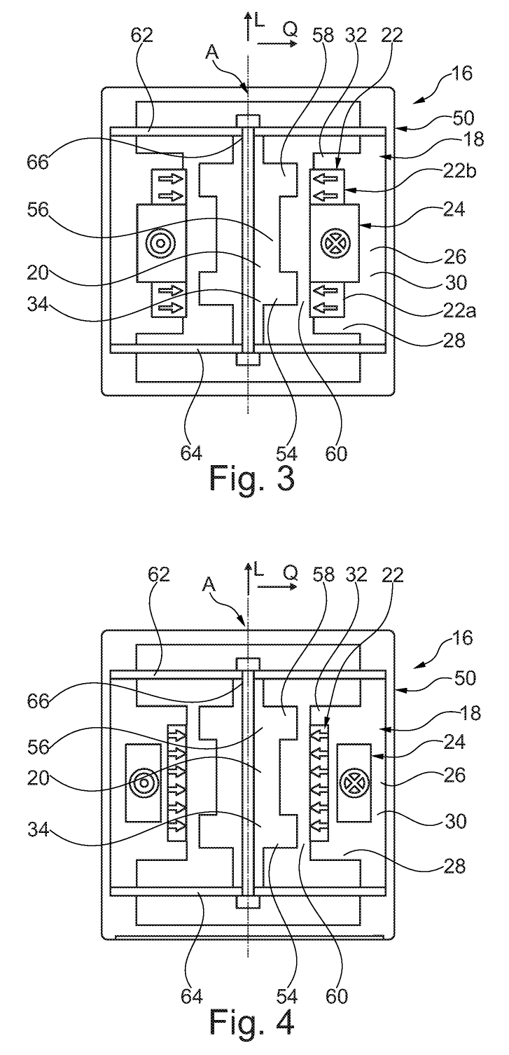

FIG. 3 shows a schematic cross-sectional view of a second embodiment of a linear actuator,

FIG. 4 shows a schematic cross-sectional view of a third embodiment of a linear actuator, and

FIG. 5 shows a schematic cross-sectional view of a further embodiment of a linear actuator.

FIG. 1 shows a hydraulic mount 2. The hydraulic mount 2 comprises a load-bearing spring 36 in the form of a rubber element. Said load-bearing spring 36 is, in the conventional manner, in the form of a hollow body, wherein the top side of the load-bearing spring 36 has a cover 38. A connection element (not illustrated) for the fastening of an engine is normally attached to the cover 38. In a simple embodiment, the connection element is a threaded bolt which can be screwed to the engine. The bottom side of the load-bearing spring 36 is adjoined by the partition 8. The working chamber 4 is formed between the load-bearing spring 36, the cover 38 and the partition 8. The working chamber 4 is filled with a hydraulic fluid. This is preferably a mixture of oil and water. Situated adjacently below the partition 8 in the longitudinal direction L is the hollow cylindrical base housing 40, the interior space of which is divided by a flexible separating body 48. The space enclosed by the partition 8, the separating body 48 and the base housing 40 forms the equalization chamber 6 of the hydraulic mount 2. The equalization chamber 6 is preferably likewise filled with hydraulic fluid. Said hydraulic fluid may likewise be a mixture of oil and water. It can thus be seen from FIG. 1 that the partition 8 is arranged between the working chamber 4 and the equalization chamber 6. For the damping of low-frequency vibrations which are exerted by the engine on the load-bearing spring 36 via the cover 38 and which thus also act on a working chamber volume 14 of the working chamber 4, a throttle duct 10 is provided which is formed between the working chamber 4 and the equalization chamber 6 and which serves for the exchange of hydraulic fluid. If the load-bearing spring 36 is compressed as a result of the vibrations, this normally leads to an increase of the pressure of the hydraulic fluid in the working chamber 4 and/or to a decrease in size of the working chamber volume 14 of the working chamber 4. Here, in both alternatives, a volume flow of the hydraulic fluid takes place from the working chamber 4 through the throttle duct 10 into the equalization chamber 6. Here, dissipation occurs in the throttle duct 10, such that the vibrations acting on the load-bearing spring 36 can be damped. The damping by way of the throttle duct 10 is however effective only for low-frequency vibrations. In the presence of relatively high-frequency vibrations, for example above 20 Hz, virtually no damping or isolation of vibrations whatsoever is effected by way of the throttle duct 10.

For the isolation of vibrations with a frequency of greater than 20 Hz, the hydraulic mount 2 has a control diaphragm 12. Said control diaphragm 12 is assigned to the partition 8. For this purpose, the control diaphragm 12 may be formed by the partition 8 itself or may be inserted into the partition 8. It is thus possible for the partition 8 to enclose the control diaphragm 12. The control diaphragm 12 is designed to be elastically deformable in the longitudinal direction L of the hydraulic mount 2. In accordance with its elastic deformability in the longitudinal direction L, the working chamber volume 14 of the working chamber 4 increases or decreases in size. Said deformability of the control diaphragm 12 is utilized advantageously to isolate relatively high-frequency vibrations. For this purpose, the control diaphragm 12 is, at its side averted from the working chamber 4, mechanically connected to an armature 20 of an electromagnetic linear actuator 16 of the hydraulic mount 2. The linear actuator 16 furthermore has a stator 18, with the armature 20 being arranged so as to be mounted movably with respect to said stator. The armature is fastened to the base housing 40 of the hydraulic mount 2 or is at least partially formed by the base housing 40. To restrict the movement direction of the armature 20 to a movement direction in the longitudinal direction L, the linear actuator 16 has a corresponding bearing arrangement. It is thus possible for the elastic deformation of the control diaphragm 12 to be electrically controlled by way of the electromagnetic linear actuator 16.

Furthermore, FIG. 1 shows an advantageous embodiment of the hydraulic mount 2 according to the invention in which the armature 20 is mechanically connected to the control diaphragm 12 by way of a mechanical plunger 46 which is assigned to the armature 20. By way of the plunger, the stator 18 of the linear actuator 16 can be arranged so as to be spaced apart from the control diaphragm 12, such that the equalization chamber 6 can form in the region between the stator 18 and the partition 8. Such an embodiment of the hydraulic mount 2 has proven to be particularly expedient in practice. Other embodiments which do not have a plunger 46 or which, instead of the plunger 46, have some other articulated mechanism for the transmission of forces of the linear actuator 16 to the control diaphragm 12 are therefore likewise intended to be regarded as a mechanical connection between the armature 20 and the control diaphragm 12.

FIG. 2 illustrates a design variant of the electromechanical linear actuator 16 in more detail. In such an embodiment, the the linear actuator 16 may also be used for other purposes and/or devices, for example a chassis mount. The linear actuator 16 comprises a stator 18 with a stator housing 50, multiple permanent magnets 22 and a coil 24. The linear actuator 16 is of symmetrical form with respect to an axis A in the longitudinal direction L.

The further explanations therefore relate initially to the right-hand half of the linear actuator 16. Owing to the symmetry, the linear actuator 16 has analogous features, embodiments and/or advantages in its opposite half.

As viewed in the longitudinal direction L, the linear actuator 16 has a lower permanent magnet 22a and an upper permanent magnet 22b. The coil 24, or at least a part of the coil 24, is arranged between the lower permanent magnet 22a and the upper permanent magnet 22b. A longitudinal section 30 of a conductive element 26 composed of ferromagnetic material is arranged radially at the outside with respect to the two permanent magnets 22a, 22b and the coil 24. The conductive element 26 is part of the stator 18. The conductive element 26 serves for concentrating a coil magnetic field of the coil 24. For this purpose, the conductive element 26 furthermore has a lower collar 28 and an upper collar 32 which extend each case in the transverse direction Q from the longitudinal section 30. As emerges from FIG. 2, the lower collar 28 engages between the lower permanent magnet 22a and the coil 24. By contrast, the upper collar 32 engages between the upper permanent magnet 22b and the coil 24. By way of the longitudinal section 30 and the two collars 28, 32, the conductive element 26 is of comb-like form. By way of the corresponding opening between the two collars 28, 32, the conductive element 26 engages of the coil 24. By way of its outer L-shaped sections which comprise in each case one of the two collars 28, 32 and a respectively adjacent end of the longitudinal section 30, the conductive element 26 engages over the two permanent magnets 22a, 22b.

The armature 20 according to the invention composed of ferromagnetic material forms a yoke 34 for the conductive element 26. The armature 20 requires neither a permanent magnet nor a coil for this purpose. The armature 20 is thus free from permanent magnets and/or coils. In practice, it has proven to be expedient if the yoke 34 formed by the armature 20 extends in the longitudinal direction L from a lower web 54 via a middle section 56 to an upper web 58. Here, each of the two webs 54 projects beyond the middle section 56 in the transverse direction Q. In a rest position of the armature 20, the upper web 58 is aligned opposite the upper collar 32 and the lower web 54 is aligned opposite the lower collar 28. In other words, the upper web 58 and the upper collar 32 are arranged in a common upper plane, and the lower web 54 and the lower collar 28 are arranged in a common lower plane. The webs 54, 58 and the collars 28, 32 thus define an air gap 60 which is formed between the armature 20 and the stator 18 in the transverse direction Q.

To ensure that the armature 20 performs the desired movement only in the longitudinal direction L, the armature 20 is arranged so as to be mounted at its top side by way of an upper guide spring 61, and at its bottom side by way of a lower guide spring 63, on the stator 18. The two guide springs 61, 63 prevent the armature 20 from being able to perform a movement in the transverse direction Q.

To effect a deflection of the armature 20 in the longitudinal direction, the coil 24 is energized. Here, a coil magnetic field is generated which is concentrated by the conductive element 26 and the yoke 34, such that circular magnetic field lines are generated. These also lead through the two collars 28, 34. The two permanent magnets 22a, 22b are arranged adjacent to the collars 28, 32, which permanent magnets have in each case a common magnetic field orientation in the transverse direction Q. Thus, in the event of an energization of the coil 24, the concentrated coil magnetic field has a permanent magnetic field of the lower permanent magnet 22a constructively superposed thereon in the lower collar 28, whereas the concentrated coil magnetic field has a permanent magnetic field of the upper permanent magnet 22b destructively superposed thereon in the upper collar 32, or vice versa. Depending on the configuration of said superposition, the armature 20 moves upward or downward in the longitudinal axial direction.

For the transmission of said movement in the longitudinal direction, the armature 20 may, in the case of the corresponding linear actuator 16 being used for a hydraulic mount 2, be fastened directly to the control diaphragm 12. The armature 20 may however also be assigned a holder 65 by way of which the armature 20 is mechanically connected to the control diaphragm 12. Said holder 65 may also be adjoined radially at the outside by the leaf springs 68 illustrated in FIG. 2, which leaf springs extend as far as the stator 18 for the purposes of mounting the armature 20 relative to the stator 18.

FIG. 3 schematically illustrates a further embodiment of the linear actuator 16. The linear actuator 16 is of substantially identical construction to the linear actuator 16 described above, as has been discussed with reference to FIG. 2. Analogous explanations, features and/or advantages thus apply. The linear actuator 16 from FIG. 3 however differs in terms of the embodiment of the conductive element 26 and the associated arrangement of the permanent magnets 22a, 22b and the coil 24. To explain the differences and the associated effects, reference is also made, as above, to the fact that the linear actuator 16 is of symmetrical construction with respect to the axis A. Therefore, the construction of the right-hand half of the linear actuator 16 will be discussed below, wherein analogous features, advantages and effects apply to the rest of the linear actuator 16.

The conductive element 26 extends from a lower collar 28 via a longitudinal section 30 to an upper collar 32. The conductive element is thus of C-shaped form. The lower permanent magnet 22a, the coil 24 and the upper permanent magnet 22 are inserted into a corresponding opening of the C-shaped form. The coil 24 is arranged between the two permanent magnets 22a, 22b. The conductive element 26 is thus designed so as to engage over the entire grouping composed of permanent magnets 22a, 22b and of the at least one coil 24. For this purpose, the collars 28, 32 engage over the longitudinally pointing face sides and the longitudinal section 30 engages over a transversely pointing face side of the abovementioned grouping. The permanent magnets 22a, 22b and the coil 24 are thus enclosed by the conductive element 26. If the coil 26 is now energized, it is the case, as before, that a coil magnetic field is generated, wherein the magnetic field lines thereof are concentrated in ring-shaped fashion by the conductive element 26 and by the yoke 34 formed by the armature 20. Furthermore, the permanent magnets are again arranged directly adjacent to the collars 28, 32, such that an analogous constructive or destructive superposition with the associated permanent magnetic field respectively occurs. The armature 20 can thus be deflected in the longitudinal direction L in controlled fashion by way of the energization of the coil 24.

FIG. 4 schematically illustrates a further embodiment of the linear actuator 16. The linear actuator 16 is of substantially identical construction to the linear actuators 16 described above, as have been discussed with reference to FIGS. 2 and 3. Analogous explanations, features and/or advantages thus apply. The linear actuator 16 from FIG. 4 however differs in terms of the embodiment of the conductive element 26 and the associated arrangement of the permanent magnets 22a, 22b and the coil 24. To explain the differences and the associated effects, reference is also made, as above, to the fact that the linear actuator 16 is of symmetrical construction with respect to the axis A. Therefore, the construction of the right-hand half of the linear actuator 16 will be discussed below, wherein analogous features, advantages and effects apply to the rest of the linear actuator 16.

As in FIG. 3, the conductive element 26 of the linear actuator 16 from FIG. 4 is of C-shaped form. However, a permanent magnet 22 and at least a part of a coil 24 have been inserted into the corresponding opening, wherein the permanent magnet 22 and the coil 24 are arranged one behind the other in the transverse direction Q. As viewed in the transverse direction Q, the permanent magnet 22 is arranged at the armature side and the coil 24 is arranged at the longitudinal section side. Thus, the conductive element 26 engages over both the permanent magnets 22 and the coil 24. In the longitudinal direction L, the permanent magnet 22 extends over the entire longitudinal extent of the coil 22 and preferably beyond. Thus, the permanent magnet 22 adjoins both the lower collar 28 and the upper collar 32. If the coil 26 is now energized, a coil magnetic field with correspondingly ring-shaped magnetic field lines is generated, which magnetic field lines are concentrated by the conductive element 26 and by the yoke formed by the armature 20. Owing to the arrangement of the permanent magnet 22 adjacent to the two collars 28, 32, the magnetic field will be constructively superposed in the lower collar 28 and will be destructively superposed in the upper collar 32, or vice versa. The armature 20 is thus subjected to a pulling force in the longitudinal direction L.

FIG. 5 schematically illustrates a further embodiment of the linear actuator 16. The linear actuator 16 is of substantially identical construction to the linear actuators 16 described above, as have been discussed with reference to FIGS. 2 to 4. Analogous explanations, features and/or advantages thus apply. The linear actuator 16 from FIG. 5 however differs in terms of the embodiment of the bearing arrangement of the armature 20.

To ensure that the armature 20 performs the desired movement only in the longitudinal direction L, it has been discussed above by way of example on the basis of exemplary embodiments that the armature 20 is fastened at its top side by way of an upper guide spring 61, and at its bottom side by way of a lower guide spring 63, to the stator 18. The two guide springs 61, 63 prevent the armature 20 from being able to perform a movement in the transverse direction Q. For this purpose, the guide springs 61, 63 must often be configured with a high stiffness. Said high stiffness can however have the disadvantage, during a movement of the armature in the longitudinal direction, that the armature 20 must bend the guide springs 61, 63 in the longitudinal direction L, such that corresponding reaction forces act on the armature 20. Said forces that arise during a movement of the armature 20 give rise to a loss of power, which does not serve for deflection, for example of the control diaphragm 12.

To avoid or at least considerably reduce said loss of power and at the same time restrict the movement direction of the armature 20 to a movement direction in the longitudinal direction L, the armature 20 may be mounted by way of a slide bearing arrangement 62. For this purpose, the slide bearing arrangement 62 has a degree of freedom in the longitudinal direction L. It can thus transmit forces in the transverse direction Q of the actuator 16. Owing to the preferred mechanical connection of the armature 20 to the control diaphragm 12, it is possible for the precision of the guidance of the armature in the longitudinal direction L to be further improved, in particular if the control diaphragm 12 is designed for accommodating forces in the transverse direction Q. The slide bearing arrangement 62 ensures that, even in the event of a deflection in the longitudinal direction L, the armature 20 has a radially outside spacing, characterized in particular by the air gap 60, with respect to the stator 18.

The slide bearing arrangement 62 particularly preferably has a very low coefficient of friction, such that a loss of power that arises as a result of the friction during a movement of the armature 20 in the longitudinal direction L is negligibly small. Under this assumption, no additional power reserves have to be allowed for in terms of construction in the actuator 16, which power reserves would otherwise be necessary in the case of known actuators in order to perform as large as possible a deflection in the longitudinal direction L. Therefore, the actuator 16 can be made altogether more compact and smaller, which furthermore makes it possible to realize a weight reduction of the actuator 16 and of the hydraulic mount 2.

As can be seen from FIG. 5, the conductive element 26 of the linear actuator 16 is again of C-shaped form in cross section. A permanent magnet 22 and a coil 24 have been inserted into the corresponding opening, which is also referred to as receiving region, wherein the permanent magnet 22 and the coil 24 are arranged one behind the other in the transverse direction Q. As viewed in the transverse direction Q, the permanent magnet 22 is arranged at the armature side and the coil 24 is arranged at the longitudinal section side. Thus, the conductive element 26 engages over both the permanent magnets 22 and the coil 24. In the longitudinal direction L, the permanent magnet 22 extends over the entire longitudinal extent of the coil 22 and preferably beyond. In other words, the permanent magnet 22 adjoins both the lower collar 28 and the upper collar 32. The lower collar 28 forms, by way of the associated side facing toward the armature 20, a stator pole surface 82, in particular a lower stator pole surface. A corresponding situation applies to the upper collar 32, which, by way of the associated side facing toward the armature 20, forms a further stator pole surface 82, in particular an upper stator pole surface. If the coil 26 is now energized, a coil magnetic field with correspondingly ring-shaped magnetic field lines is generated, which magnetic field lines are concentrated by the conductive element 26 and by the yoke 34 formed by the armature 20. Owing to the arrangement of the permanent magnet 22 adjacent to the two collars 28, 32, the magnetic field will be constructively superposed in the lower collar 28 and will be destructively superposed in the upper collar 32, or vice versa. The armature 20 is thus subjected to a pulling force in the longitudinal direction L.

The armature 20 composed of or comprising ferromagnetic material forms, as mentioned above, a yoke 34 for the conductive element 26. The armature 20 requires neither a permanent magnet nor a coil for this purpose. The armature 20 is thus free from permanent magnets and/or coils. In practice, it has proven to be expedient if the yoke 34 formed by the armature 20 extends in the longitudinal direction L from a lower section 84 via a middle section 56 to an upper section 86. In a rest position of the armature 20, the upper section 84 is aligned opposite the upper collar 32 and the lower section 86 is aligned opposite the lower collar 28. In other words, the upper section 84 and the upper collar 32 are arranged in a common upper plane, and the lower section 86 and the lower collar 28 are arranged in a common lower plane. The lower section 84 of the armature 20 forms, by way of the associated side facing toward the stator 18, an armature pole surface 80, in particular a lower armature pole surface. A corresponding situation applies to the upper section 86, which, by way of the associated side facing toward the stator 18, forms a further armature pole surface 80, in particular an upper armature pole surface. The lower armature section 84, the upper armature section 86 and the collars 28, 32 thus define an air gap 60 which forms in each case in the region between one of the armature pole surfaces 80 and a stator pole surface 82, arranged opposite said one of the armature pole surfaces, in the transverse direction Q. Here, the air gap 60 has a gap width B in the transverse direction Q.

It can be seen from FIG. 5 that the slide element 70 is enclosed in the longitudinal direction L in a depression 88 of the stator 18 between the lower collar 28 and the upper collar 32. The slide element 70 is thus arranged between the upper collar 32 and the lower collar 28 in the longitudinal direction L of the linear actuator 16. Thus, the slide element 70 does not overlap the stator pole surfaces 82 of the stator 18. It is thus possible for the stator pole surfaces 82 and the armature pole surfaces 80 to be arranged opposite one another in pairwise fashion in a rest position of the linear actuator 16. As discussed above, the armature pole surfaces 80 are formed on a respective side, facing toward the stator 18, of the lower armature section 84 and of the upper armature section 86. The middle section 56 of the armature 20 is between the lower armature section 84 and the upper armature section 86. Here, that side of the middle section 56 of the armature 20 which faces toward the stator 18 forms a bearing surface 90 of the slide bearing arrangement 62. The armature 20 lies by way of the bearing surface 90 directly against the slide element 70. The slide element 70 thus forms, with the side facing toward the armature 20, a counterpart bearing surface 92 of the slide bearing arrangement 62.

To prevent the armature pole surfaces 80 from abutting against the stator pole surfaces 82 and thus giving rise to undesired mechanical friction, the slide element 70 projects in the transverse direction Q beyond the stator pole surfaces 82 formed by the collars 28, 32. The height in the transverse direction Q by which the slide element 70 projects beyond the stator pole surfaces 82 simultaneously defines the gap width B of the air gap 60. As can also be seen from FIG. 5, it is however also the case that a part of the slide element 70 is enclosed in the depression 88, such that the gap width B is smaller than the slide element width G. This has the further advantage that the slide element 70 can have an adequately large slide element width G which ensures adequately high structural stability of the slide element 70. Despite the relatively large slide element width G, the air gap width B can be kept particularly small, which reduces the magnetic resistance at the air gap 60. The arrangement of the slide element 70 between the collars 28, 32 of the stator 18, with partial enclosure in the depression 88 of the stator 18, thus makes it possible to realize an advantageous bearing arrangement of the armature 20 with simultaneous low magnetic resistance at the air gap 60.

Furthermore, it can be seen from FIG. 5 that the lower armature section 84, the middle section 56 of the armature 20 and the upper armature section 86 are of uninterrupted form. This permits particularly simple production of the armature 20. Furthermore, the bearing surface 90 of the slide bearing arrangement 62 and the armature pole surfaces 80 provided for the yoke 34 can be formed on a common, uninterrupted armature side 94. With this embodiment, a particularly compact construction of the linear actuator 16 can be ensured. This is because, in the event of a deflection of the armature 20 in the longitudinal direction L, the armature 20 can slide with the upper armature section 86 or the lower armature section 84 over the counterpart bearing surface 92 without problems. This is the case in particular if the armature pole surfaces 80 and the bearing surface 90 are arranged in alignment with one another. If a corresponding deflection of the armature 20 now occurs, the bearing surface 90 formed by the armature 20 is displaced into the upper armature section 86 or into the lower armature section 84. A corresponding situation applies to the armature pole surfaces 80, which may now be formed partially by the middle section 56 of the armature 20. In other words, the various sections 28, 84, 86 of the armature 20 perform dual functions and simultaneously permit a deflection of the armature 20 with low resistance.

### LIST OF REFERENCE SIGNS

### Part of the Description

A Axis
L Longitudinal direction
Q Transverse direction
B Gap width
G Slide element width
2 Hydraulic mount
4 Working chamber
6 Equalization chamber
8 Partition
10 Throttle duct
12 Control diaphragm
14 Working chamber volume
16 Linear actuator
18 Stator
20 Armature
22 Permanent magnet
22a Lower permanent magnet
22b Upper permanent magnet
24 Coil
26 Conductive element
28 Lower collar
30 Longitudinal section
32 Upper collar
34 Yoke
36 Load-bearing spring
38 Cover
40 Base housing
46 Plunger
48 Separating body
50 Stator housing
54 Lower web
56 Middle section
58 Upper web
60 Air gap
61 Upper guide spring
62 Slide bearing arrangement
63 Lower guide spring
65 Holder
70 Slide element
80 Armature pole surface
82 Stator pole surface
84 Lower section
86 Upper section
88 Depression
90 Bearing surface
92 Counterpart bearing surface
94 Armature side

1.-25. (canceled)

26. An electromagnetic linear actuator comprising:
a stator comprising at least one permanent magnet and at least one coil; and,
an armature which is movable relative to the stator;
wherein the stator further comprises a conductive element composed of ferromagnetic material, wherein the conductive element engages over the at least one permanent magnet and/or the at least one coil, and wherein the armature forms, in a longitudinal direction L, a yoke composed of the ferromagnetic material for the conductive element.

27. The linear actuator as claimed in claim 26, wherein the conductive element comprises a longitudinal section extending in the longitudinal direction L of the linear actuator, a lower collar extending in a transverse direction Q of the linear actuator, and an upper collar extending in the transverse direction Q of the linear actuator, and wherein the lower collar is spaced apart from the upper collar in the longitudinal direction L.

28. The linear actuator as claimed in claim 27, wherein each of the lower collar and the upper collar projects beyond the longitudinal section in the same transverse direction Q, and wherein the at least one permanent magnet and/or the at least one coil are/is arranged between the lower collar and the upper collar.

29. The linear actuator as claimed in claim 26 comprising at least two permanent magnets, wherein the at least one coil is arranged between the at least two permanent magnets in the longitudinal direction L.

30. The linear actuator as claimed in claim 26 comprising at least two coils, wherein the at least one permanent magnet is arranged between the at least two coils in the longitudinal direction L.

31. The linear actuator as claimed in claim 26, wherein at least one of the at least one permanent magnet is arranged behind or in front of the at least one coil in the transverse direction Q.

32. The linear actuator as claimed in claim 26, wherein the at least one coil directly adjoins at least one of the at least one permanent magnets.

33. The linear actuator as claimed in claim 26, wherein the armature is mounted by way of a slide bearing arrangement.

34. The linear actuator as claimed in claim 33, wherein the slide bearing arrangement is at least substantially free from ferromagnetic material.

35. The linear actuator as claimed in claim 33, wherein the armature forms, on an associated side facing toward the stator, a bearing surface of the slide bearing arrangement, and wherein a slide element of the slide bearing arrangement is fastened to a stator side facing toward the armature, the slide element, by way of an associated side facing toward the armature, forms a counterpart bearing surface of the slide bearing arrangement.

36. The linear actuator as claimed in claim 35, wherein the slide element is arranged between an upper collar and a lower collar in the longitudinal direction L of the linear actuator.

37. The linear actuator as claimed in claim 36, wherein the slide element is enclosed in the stator between the lower collar and the upper collar.

38. The linear actuator as claimed in claim 36, wherein the slide element projects in transverse direction Q beyond stator pole surfaces formed by the lower collar and the upper collar.

39. The linear actuator as claimed in claim 35, wherein the bearing surface of the slide bearing arrangement and armature pole surfaces provided for the yoke are formed on a common, uninterrupted armature side.

40. The linear actuator as claimed in claim 35, wherein a stator pole surface of the stator and an armature pole surface of the armature arranged opposite the stator pole surface, are spaced apart from one another in the transverse direction Q of the linear actuator by a gap, wherein a gap width B of the gap is smaller than a slide element width G of the slide element.

41. A hydraulic mount comprising a load-bearing spring, a working chamber filled with a hydraulic fluid, an equalization chamber, a partition which is arranged between the working chamber and the equalization chamber, a throttle duct formed between the working chamber and the equalization chamber, which serves for exchange of hydraulic fluid, and a control diaphragm which is assigned to the partition and which is designed for the variation of a working chamber volume of the working chamber;
wherein the hydraulic mount comprises an electromagnetic linear actuator comprising:
a stator comprising at least one permanent magnet and at least one coil; and,
an armature which is movable relative to the stator;
wherein the stator further comprises a conductive element composed of ferromagnetic material;
wherein the conductive element engages over the at least one permanent magnet and/or the at least one coil;
wherein the armature forms, in a longitudinal direction L, a yoke composed of the ferromagnetic material for the conductive element; and,
wherein the armature is mechanically connected to the control diaphragm.

42. The hydraulic mount as claimed in claim 41, where the armature is composed of one of the yoke or the yoke and a holder, for the connection of the yoke to the control diaphragm.

43. The hydraulic mount as claimed in claim 41, wherein the hydraulic mount is used as an engine mount for a motor vehicle, and wherein the motor vehicle comprises a vehicle frame, an engine, and the engine mount which produces a connection, with mounting action, between the engine and the vehicle frame.

44. An electromagnetic linear actuator comprising a stator comprising a conductive element composed of ferromagnetic material, and an armature which is movable relative to the stator;
wherein the armature is mounted by way of a slide bearing arrangement;
wherein the armature forms, on an associated side facing toward the stator, a bearing surface of the slide bearing arrangement; and,
wherein a slide element of the slide bearing arrangement is fastened to a stator side facing toward the armature, the slide element, by way of an associated side facing toward the armature, forms a counterpart bearing surface of the slide bearing arrangement.

45. The linear actuator as claimed in claim 44, wherein the slide bearing arrangement is at least substantially free from ferromagnetic material.

46. The linear actuator as claimed in claim 44, wherein the stator comprises at least one permanent magnet and at least one coil, and wherein the conductive element engages over the at least one permanent magnet and/or the at least one coil, and wherein the armature forms, in a longitudinal direction L, a yoke composed of the ferromagnetic material for the conductive element.
